(19) United States
(12) Patent Application Publication
(10) Pub. No.: US 2007/0105418 A1
(43) Pub. Date: May 10, 2007

(54) WIRELESS SIGNAL TRANSMISSION APPARATUS

(75) Inventors: Jo-Wang Fu, Hsinchu (TW); Chien-Chih Lai, Hsinchu (TW)

Correspondence Address: J C PATENTS, INC., 4 VENTURE, SUITE 250, IRVINE, CA, 92618, US

(73) Assignee: CORETRONIC CORPORATION, Hsinchu (TW)

(21) Appl. No.: 11/536,362

(22) Filed: Sep. 28, 2006

(30) Foreign Application Priority Data
Nov. 9, 2005 (TW) 94139225

(51) Int. Cl. H01R 13/44; H01R 33/00; G06F 13/00

(52) U.S. Cl. 439/136; 439/916; 439/638; 710/300

(57) ABSTRACT

A wireless transmission apparatus including a signal output/input port and an antenna module is provided. The antenna module is used for receiving and transmitting wireless signals satisfying a transmission standard IEEE 802.11. The antenna module is electrically connected to the signal output/input port. Furthermore, the antenna module is rotated with respect to the signal output/input port. The antenna module has two degrees of freedom in rotation directions, such that it is easy to adjust the position of antenna module so that the wireless transmission apparatus has a good signal receiving quality.

### CROSS-REFERENCE TO RELATED APPLICATION

This application claims the priority benefit of Taiwan application serial no. 94139225, filed on Nov. 9, 2005. All disclosure of the Taiwan application is incorporated herein by reference.

### BACKGROUND OF THE INVENTION

1. Field of Invention

The present invention relates to a signal transmission apparatus. More particularly, the present invention relates to a wireless signal transmission apparatus.

2. Description of Related Art

In recent years, the cathode ray tube (CRT) projection apparatus with large volume and heavy weight has been gradually replaced with products, such as the liquid crystal projection apparatus or digital light processing (DLP) projection apparatus. The products are light, thin, and also portable, and are directly connected with other digital apparatus for projecting images. Under the situation that manufacturers continuously provide new and competitive products with low price and more additional functions, the products are not only used in company, school, or public area for presentations, but also be used at home.

As the great and prompt development in production, now, the projection apparatus has to have many functions, and the outer appearance of the projection apparatus has to be satisfy the requirements of being light, thin, and small. In addition, the manufacturers are continuously looking for high efficiency and more convenience in operation. Further, the projection apparatus in current development has the capability with wireless signal transmission, so as to improve the convenience for a user, and reduce the bothering issue of many wire connections. However, the wireless projection apparatus uses the antenna on the wireless network card to receive and transmit wireless signal. In this manner, when the wireless projection apparatus has the situation in poor signal receiving, the position of the whole wireless projection apparatus has to be adjusted, so as to solve the situation in poor signal receiving. It is inconvenient to the user.

### SUMMARY OF THE INVENTION

An object of the present invention is to provide a wireless signal transmission apparatus having an antenna module, the antenna module has more degrees of freedom in rotation directions. As a result, the signal receiving quality of the wireless signal transmission apparatus is improved.

To achieve the above-mentioned object, the present invention provides a wireless signal transmission apparatus including a signal input/output (I/O) port and an antenna module. The antenna module is used for receiving and transmitting wireless signal and the wireless signal satisfies the transmission standard of IEEE 802.11. Particularly, the antenna module is electrically connected to the signal I/O port, and relatively rotates with respect to the signal I/O port. The foregoing antenna module is, for example, an image signal transceiver module or a video signal transceiver module, and the signal I/O port is the signal I/O port of the video graphic array (VGA) interface, or digital visual interface (DVI).

In an embodiment, the foregoing wireless signal transmission apparatus, for example, further includes a first pivotal coupling member and a second pivotal coupling member, which are coupled between the antenna module and the signal I/O port. The rotation directions for the first pivotal coupling member and the second pivotal coupling member are different and the antenna module rotates with respect to the signal I/O port by the rotations about the rotation axes of the first pivotal coupling member and the second pivotal coupling member respectively. The rotation axes of the first pivotal coupling member and the second pivotal coupling member are, for example, perpendicular to each other.

In an embodiment, the foregoing wireless signal transmission apparatus, for example, further includes a signal processing module electrically coupled between the antenna module and the signal I/O port. The signal processing module includes, for example, a microprocessing unit and an encoding/decoding unit.

The antenna module of the invention has two degrees of freedom in the rotation directions, so that it is easily adjusted to a proper position. The wireless signal transmission apparatus of the invention has good signal receiving quality.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a perspective view schematically illustrating a wireless signal transmission apparatus according to an embodiment of the invention.

FIG. 2 is a bottom view schematically illustrating a wireless signal transmission apparatus according to an embodiment of the invention.

FIG. 3 is a block diagram schematically illustrating the circuit of the wireless signal transmission apparatus according to an embodiment of the invention.

### DESCRIPTION OF THE PREFERRED EMBODIMENTS

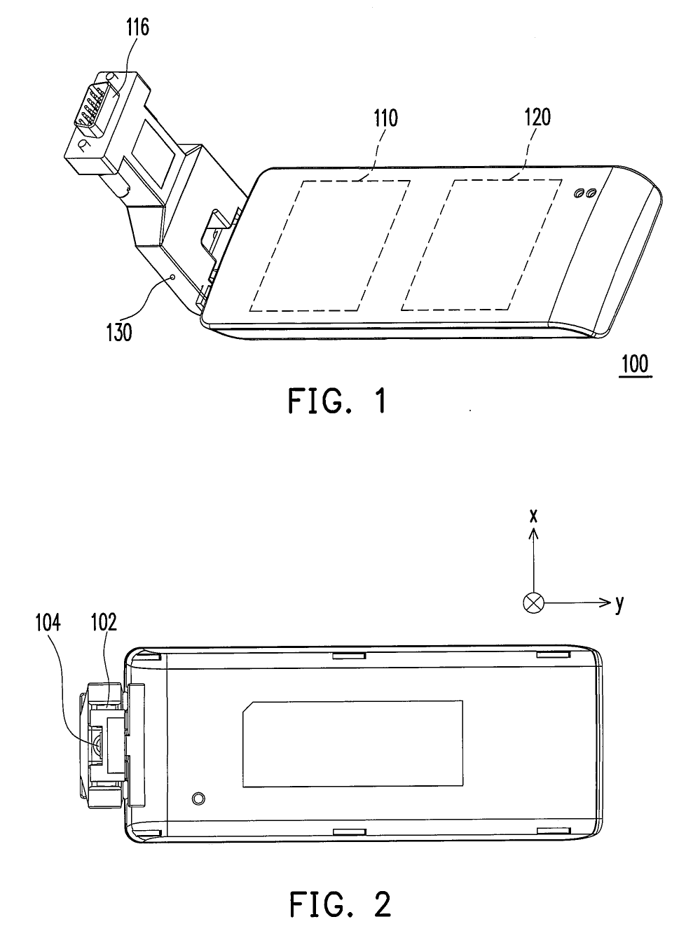

Referring to FIG. 1 and FIG. 2, a wireless signal transmission apparatus 100 includes a signal I/O port 116 and an antenna module 120. The antenna module 120 is used for receiving and transmitting wireless signal. Particularly, the antenna module 120 is rotatably coupled to the signal I/O port 116. In addition, the power of the wireless signal transmission apparatus 100 is, for example, an independent external-connection power source. For example, the wireless signal transmission apparatus 100 is, for example, connected to the external electric power source via a power input terminal 130.

Referring to FIG. 1 and FIG. 2, the antenna module 120 of the embodiment is, for example, coupled to the signal I/O port 116 via a first pivotal coupling member 102 and a second pivotal coupling member 104, and the rotation axes of the first pivotal coupling member 102 and the second pivotal coupling member 104 are perpendicular to each other. In this manner, the antenna module 120 rotates with respect to the signal I/O port 116 about the rotation axes of the first pivotal coupling member 102 and the second pivotal coupling member 104, so that it is convenient to adjust the signal receiving quality. In FIG. 2, the rotation axis of the first pivotal coupling member 102 is, for example, parallel to the X axis, the rotation axis of the second pivotal coupling member 104 is, for example, parallel to the Z axis. The antenna module 120, for example, takes the X axis and the Z axis as the rotation center and rotates with respect to the signal I/O port. In other words, the antenna module 120 has two degrees of freedom in rotation directions.

Remarkably, the wireless signal transmission apparatus 100 is, for example, using the wireless transmission standard IEEE 802.11 for transmitting wireless signal. In other words, the wireless signal transmission apparatus 100 receives the wireless signals from the Ethernet and transmits the wireless signals to the Ethernet. The one skilled in the art knows that the wireless signal transmission apparatus 100 transmits wireless signals, satisfying the transmission standards of IEEE 802.11a, IEEE 802.11b, IEEE 802.11g, and so on.

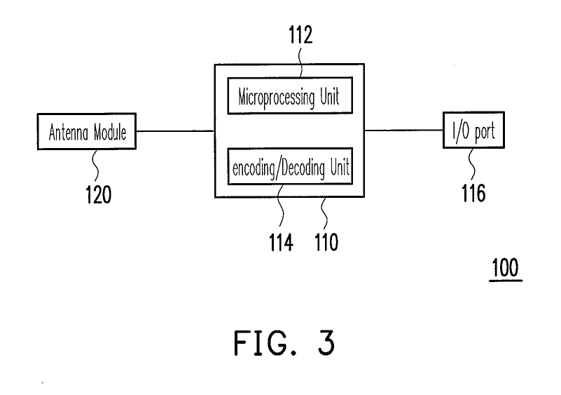

Referring to FIG. 3, according to another embodiment of the invention, the wireless signal transmission apparatus 100 further includes a signal processing module 110, which is electrically coupled between the antenna module 120 and the signal I/O port 116. The signal processing module 110 includes, for example, a microprocessing unit 112 and an encoding/decoding unit 114. After the antenna module 120 sends the received wireless signals to the signal processing unit 110, the encoding/decoding unit 114 performs the encoding/decoding process and the results are exported via the signal I/O port 116. In addition, when the wireless signal transmission apparatus 100 transmits the signals to the Ethernet, the output signals from the encoding/decoding unit 114 are processed by the microprocessing unit 112 and then are transmitted to the Ethernet via the antenna module 120.

In addition, the signal processing module 110 is, for example, relatively affixed to the antenna module 120. In other words, the signal processing module 110 and the antenna module 120 are disposed on the same side of the first pivotal coupling member 102 and the second pivotal coupling member 104, so that the signal processing module 110 and the antenna module 120 are rotated with respect to the signal I/O port 116.

In addition, the signal I/O port 116 is, for example, the signal I/O port of the video graphic array (VGA) interface. Certainly, in another embodiment, the signal I/O port 116 can be, for example, the signal I/O port of the digital visual interface (DVI). The wireless signal transmission apparatus 100 is used for transmitting image signals or audio signals to an image output apparatus. The image output apparatus is, for example, a projecting apparatus or a common display screen.

In summary, the invention has at least several advantages as follows:

1. Since the antenna module can be rotated with respect to the signal I/O port, by adjusting the antenna module, it allows the electronic apparatus use the wireless signal transmission apparatus according to the embodiment of the invention to receive the signals with sufficiently good receiving quality. In addition, the antenna module has two degrees of freedom in the rotation directions, which further increase the signal receiving quality of the wireless signal transmission apparatus of the invention.

2. In operation, the wireless signal transmission apparatus of the invention can be easily assembled and disassembled without occupying space. In addition, the invention needs no addition interface for communication with the connected electronic apparatus.

3. The wireless signal transmission apparatus independently connected to the external power source without sharing the power with the connected electronic apparatus.

It will be apparent to those skilled in the art that various modifications and variations can be made to the structure of the present invention without departing from the scope or spirit of the invention. In view of the foregoing descriptions, it is intended that the present invention covers modifications and variations of this invention if they fall within the scope of the following claims and their equivalents.

What is claimed is:

1. A wireless signal transmission apparatus, comprising:
a signal input/outpour (I/O) port; and
an antenna module, used for transmitting and receiving wireless signal, the antenna module being electrically coupled to the signal I/O port, and relatively rotating with respect to the signal I/O port, the wireless signal satisfying a transmission standard of IEEE 802.11.

2. The wireless signal transmission apparatus of claim 1, wherein the antenna module comprises an image transceiver module and a video transceiver module alternatively.

3. The wireless signal transmission apparatus of claim 1, wherein the signal I/O port comprises a signal I/O port of a video graphic array (VGA) interface and digital visual interface (DVI) alternatively.

4. The wireless signal transmission apparatus of claim 1, further comprising a first pivotal member and a second pivotal member coupled between the antenna module and the signal I.O port, wherein rotation axes of the first pivotal member and the second pivotal member are different, and the antennal module is rotated relatively to the signal I/O port about the rotation axes of the first pivotal member and the second pivotal member respectively.

5. The wireless signal transmission apparatus of claim 4, wherein the rotation axes of the first pivotal member and the second pivotal member are perpendicular to each other.

6. The wireless signal transmission apparatus of claim 1, further comprising a signal processing module electrically coupled between the antenna module and the signal I/O port.

7. The wireless signal transmission apparatus of claim 6, wherein the signal processing module comprises a microprocessing unit and an encoding/decoding unit.

8. The wireless signal transmission apparatus of claim 1, wherein the wireless signal transmission apparatus is coupled to an image output device via the signal I/O port.

9. The wireless signal transmission apparatus of claim 1, wherein the wireless signal transmission apparatus is coupled to a screen or a projecting apparatus via the signal I/O port.

10. A wireless signal transmission apparatus suitable for use in a projecting apparatus, the wireless signal transmission apparatus comprising:
a signal input/output (I/O) port; and
an antenna module, used for receiving and transmitting wireless signal, the antenna module being electrically coupled to the signal I/O port, and rotating with respect to the signal I/O port.

11. The wireless signal transmission apparatus of claim 10, further comprising a first pivotal member and a second pivotal member coupled between the antenna module and the signal I/O port, wherein rotation axes of the first pivotal member and the second pivotal member are different, and the antennal module is rotated relatively to the signal I/O port about the rotation axes of the first pivotal member and the second pivotal member respectively.

12. The wireless signal transmission apparatus of claim 11, wherein the rotation axes of the first pivotal member and the second pivotal member are perpendicular to each other.

13. The wireless signal transmission apparatus of claim 10, further comprising a signal processing module electrically coupled between the antenna module and the signal I/O port.

14. A wireless signal transmission apparatus suitable for use in a projecting apparatus, the wireless signal transmission apparatus comprising:
a signal input/output (I/O) port;
an antenna module used for receiving and transmitting wireless signal, the antenna module being electrically coupled to the signal I/O port, and rotating with respect to the signal I/O port;
a first pivotal member coupled between the antenna module and the signal I/O port; and
a second pivotal member coupled between the antenna module and the signal I/O port, wherein rotation axes of the first pivotal member and the second pivotal member are different, and the antennal module is rotated relatively to the signal I/O port about the rotation axes of the first pivotal member and the second pivotal member.

15. The wireless signal transmission apparatus of claim 14, wherein the rotation axes of the first pivotal member and the second pivotal member are perpendicular to each other.

16. The wireless signal transmission apparatus of claim 14, further comprising a signal processing module electrically coupled between the antenna module and the signal I/O port.

17. The wireless signal transmission apparatus of claim 14, wherein a wireless transmission standard of the wireless signal is IEEE 802.11.
